(19) United States
(12) Patent Application Publication
(10) Pub. No.: US 2020/0051068 A1
(43) Pub. Date: Feb. 13, 2020

(54) DYNAMIC PROVISIONING OF WALLETS IN A SECURE PAYMENT SYSTEM

(71) Applicant: Radpay, Inc., Phoenix, AZ (US)

(72) Inventor: Dana Love, Phoenix, AZ (US)

(21) Appl. No.: 16/593,717

(22) Filed: Oct. 4, 2019

Related U.S. Application Data
(63) Continuation-in-part of application No. 16/503,177, filed on Jul. 3, 2019.
(60) Provisional application No. 62/693,864, filed on Jul. 3, 2018.

(51) Int. Cl. G06Q 20/36; G06Q 20/38

(52) U.S. Cl. CPC G06Q 20/367; G06Q 2220/00; G06Q 20/3829

(57) ABSTRACT

Methods and systems for securely conducting a transaction requiring approval via a personal device of a purchaser is provided. In some embodiments, under control of a payment application executing on the personal device of a purchaser, the method establishes secure connection to a payment terminal of a seller. The method receives via the secure connection transaction information generated by a point-of-sale system. The method prompts the purchaser to approve the transaction. Upon approval, the method sends via the secure connection with the payment terminal an indication of the approved transaction to a digital payment guardian system. Under control of the digital payment guardian system, the method adds the approved transaction to a distributed ledger upon receiving the approved transaction. The method settles the approved transaction and provides notification of the settlement to the point-of-sale system so that the point-of-sale system can close the transaction.

### CROSS-REFERENCE TO RELATED APPLICATIONS

This application is a continuation in part of U.S. patent application Ser. No. 16/503,177, filed on Jul. 3, 2019, titled BLOCKCHAIN-BASED SECURE PAYMENT SYSTEM, which claims the benefit of U.S. Provisional Patent Application No. 62/693,864, filed Jul. 3, 2018, titled A BLOCKCHAIN-BASED SECURE PAYMENT SYSTEM, which are incorporated herein by reference in its entirety.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. The signing by the owner of the bitcoin is an authorization by the owner to transfer ownership of the bitcoin to the new owner via the new transaction. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions fora bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity, and when performing actions against tokens, ownership proof is established by providing a signature generated by the owner private key and validated against the public key listed as the owner of the token. A person can be uniquely identified, for example, using a combination of a user name, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) may be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection may be a cryptographic one-way hash of the digital tokens of the assets in the collection. The creation of an identity token for an asset in a blockchain establishes provenance of the asset, and the identity token can be used in transactions (e.g., buying, selling, insuring) involving the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by the car's vehicle identification number. The account for the car identifies the current owner. The current owner creates a transaction against the account for the car that indicates that the transaction is a transfer of ownership, indicates the public keys (i.e., identity tokens) of the current owner and the next owner, and indicates the identity token of the car. The transaction is signed by the private key of the current owner, and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be the identity tokens of the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, it requires large amounts of computer resources to support such redundant execution of computer code.

Purchase transactions between retailers (or merchants) and purchasers (or customers) are typically paid for with credit cards. Credit card purchases, however, are particularly vulnerable to fraud. Any person with access to credit card (e.g., a stolen credit card) for in-store purchases or credit card information (e.g., purchased on the web) for online purchases can make a purchase without the approval of the credit card holder. Although consumer protection laws may provide some degree of protection for the credit card holder (assuming the fraud is noticed), the credit card company may be liable for the fraudulent purchase. To help prevent such fraudulent purchases, a credit card company may employ extensive fraud protection mechanism. For example, if a purchase is made at a retailer in a geographic area in which the credit card holder does not normally use the credit card (e.g., a different country), the credit card company may put a fraud alert on the account and decline the purchase transaction. To remove a fraud alert, a credit card holder may need to contact the credit card company, provide the necessary credentials, prove that the transaction is not fraudulent, and again attempt to make the purchase. The time needed to remove the fraud alert can present problems for various types of purchases such as a purchase for a ticket on a train or plane that is about to depart, for a toll road, and so on.

### BRIEF DESCRIPTION OF THE DRAWINGS

FIG. 1 is a flow diagram that illustrates the processing of a transaction smart contract of the secure payment system in some embodiments.

FIG. 2 is a flow diagram that illustrates the processing of a RT creation smart contract of the secure payment system in some embodiments.

FIG. 3 illustrates a methodology in which a payment terminal has a wireless capability.

FIG. 4 illustrates a methodology in which a payment terminal and/or POS terminal has a wireless capability.

FIG. 5 illustrates a methodology in which no payment terminal is available and the POS terminal does not have wireless capability.

FIG. 6 illustrates a methodology in which neither the payment terminal nor the POS terminal has wireless capability.

FIG. 7 illustrates a methodology in which neither the payment terminal noted POS terminal have SPN capabilities.

FIG. 8 illustrates methodologies for employing SPN capabilities at an e-commerce web site.

FIG. 9 is a flow diagram that illustrates the processing of a transaction smart contract of the secure payment system in some embodiments.

FIG. 10 is a flow diagram that illustrates the processing of a PT creation smart contract of the secure payment system in some embodiments.

FIG. 11 illustrates methodologies of the SPN system for paying from purchaser account by presenting a credit card at a payment terminal.

FIG. 12 illustrates methodologies of the SPN system for handling credit card payments and when the purchaser has no purchaser account, opening a purchaser account.

### DETAILED DESCRIPTION

A secure payment network system is provided that support an infrastructure for smart contracts to enforce merchant settlements with associated consumer payment methodologies. In some embodiments, the framework of the secure payment network (“SPN”) system provides scalable support for a high number (potentially tens of millions) of transactions per second using blockchain technology such as Plasma on Ethereum blockchain. The SPN system allows for consumers to make secure payments at retail establishments (including physical and online) using cryptocurrency wallets and cryptocurrencies with the aid of consumer (purchaser) personal devices (e.g., smartphones). The SPN network system provides a common infrastructure for interfacing personal devices, payment terminals (e.g., credit/debit card terminals), point-of-sale (“POS”) terminals, and a digital payment guardian (“DPG”) system of the SPN system that supports a variety of payment methodologies. In addition, to ensuring security, the SPN system enforces a user approval mechanism through which transactions require approval using the personal devices of the purchasers. Thus, even if a purchaser's credit card information is stolen, transactions using that credit card information will be denied because the fraudulent purchaser will not have access to the purchaser's personal device to provide the approval. The SPN system supports secure transmission of approval information using various encryption techniques such as asymmetric encryption (e.g., private/public keypair encryption) and/or symmetric encryption (e.g., Diffie-Hellman key exchange). To help reduce the risk of fraudulent purchases to retailers and/or purchasers, the SPN system may allocate payment network tokens (“PTs”) to purchasers as part of a purchase transactions handled through the payment network system. The PTs may be used to pay for purchases using the SPN system. In this way, purchasers have an incentive to purchase from retailers who support secure transactions using the SPN system. Because of the efficiencies and security provided by the SPN system, transaction fees associated with conventional payment methodologies can be avoided or reduced and the cash positions of retailers is improved. Also, liability of a credit card company for fraudulent purchases can be reduced. The SPN system is described primarily in the context of credit card accounts and information. The SPN system may be used with other types of accounts such a debit accounts, gift card accounts, loyalty accounts, line of credit accounts, and so on.

In some embodiments, the SPN system employs wireless technology to support communications between personal devices, payment terminals, POS terminals, and the DPG system. During the checkout process, depending the payment methodology supported by the retailer, the payment terminal, the POS terminal, or the DPG system pushes via a secure communications channel information describing the transaction to a purchaser payment application of the SPN system installed on the personal device of the purchaser. The secure communications channel may be established by the purchaser payment application exchanging public keys of a public/private keypair. Messages sent via the secure communications channel may be encrypted with the recipient's public key and decrypted with the recipient's private key or the public keys may be used to establish a symmetric key for encrypting and decrypting messages. The payment application displays information describing the transaction to the purchaser and prompts the purchase to approve or decline. When the purchaser approves, the payment application sends an approval notification to the payment terminal, the POS terminal, or the DPG system again depending on the payment methodology supported by the retailer. The payment terminals and the POS terminals may also have payment applications of the SPN system for coordinating the processing of payments via the SPN system. The DPG system eventually receives an indication of the approved transaction and settles the transaction by recording transaction information in a blockchain (or more generally distributed ledger), debiting an account of the purchaser, crediting an account of the retailer, and issuing PTs.

In some embodiments, to participate in the SPN, a purchaser establishes a purchaser wallet with the SPN system. A purchaser wallet (also referred to as purchaser account) may be linked to an underlying account (e.g., bank account) of the purchaser and store credentials (e.g., private key) for access to PTs of the purchaser. The PTs may be allocated to the purchaser during a transaction, transferred to the purchaser from another purchaser (e.g., charitable contribution), or purchased by the purchaser. The DPG system may have a DPG wallet that stores credentials for cryptocurrency tokens (“CT”) used to underpin the PTs. The cryptocurrency tokens (e.g., EIP20 tokens) can be purchased and sold on an exchange (e.g., Bittrex and Coinbase) using fiat currency. The DPG system may maintain an allocation of reserve CTs in the DPG wallet or may purchase or mint CTs on demand. A retailer who participates in the SPN may have a retailer wallet that may be linked to an underlying account. A retailer wallet may only be used to store CTs corresponding the net transaction value while a transaction is being settled. As part of the settlement, the DPG system may direct that the CTs of the retailer wallet be exchanged for fiat currency, which is then deposited in the linked account of the retailer.

In some embodiments, when the DPG system receives the indication of an approved transaction (i.e., approved using a personal device of a purchaser), the DPG system settles the transaction. To settle the transaction, the DPG system may debit the transaction amount of fiat currency from the purchaser wallet of the purchaser. The DPG system may then exchange the transaction amount for CTs (e.g., from the reserve of CTs or newly purchased CTs) and hold the CTs in escrow for settlement of the transaction. The DPG system then calculates a transaction fee and a PT fee in cryptocurrency for the transaction. The DPG system then mints PTs corresponding to the PT fee and links the PTs to an equivalent amount of CTs held in escrow. The PTs are referred to as the underpinned tokens, and the CTs are referred to as the underpinning tokens. The DPG system transfers the PTs to the purchaser wallet of the purchaser. The DPG system also transfers a net transaction amount (e.g., transaction amount minus fees) of CTs from escrow to the retailer wallet of the retailer and then, depending on preference of the retailer, may automatically exchange the CTs for fiat currency and credits the account linked to the retailer wallet of the retailer. The DPG system then transfers the CTs remaining in escrow (i.e., a transaction fee amount) to the DPG wallet. The DPG system may store the transaction in the blockchain when it receives the approval. Alternatively, the purchaser application, payment terminal application, or POS terminal application may store the transaction in the blockchain, and the DPG system may store update transactions such as transactions to transfer PTs and CTs, to mark the transactions as settled, and so on.

As mentioned above, the SPN system provides a PT that is tied to an underpinning cryptocurrency. The PT establishes a store of value for the CT underpinning the PT, which can be used as a medium of exchange with transactions. The CT is established as a unit of account as each transaction on the SPN is tied to the value of local fiat currency, and each PT is simultaneously linked to that local fiat currency and to a measure of the CT. As such, a PT and CT pair represent a secure digital currency.

In some embodiments, the CT (i.e., underpinning cryptocurrency token) may be an EIP20 compatible token on the Ethereum blockchain. A CT may be required for access to the SPN, such that participation in the SPN is established through the presence of a certain threshold of CTs in the wallets of participants (e.g., retailers) in the SPN. The CTs provide virtual crypto “fuel” for using certain designated functions on the SPN such as executing transactions and running distributed applications that interface with the SPN system.

In some embodiments, the PT may be as an EIP20 token on the Ethereum blockchain. The SPN system mints PTs when processing a transaction. The underpinning cryptocurrency (i.e., CT) of the PT is funded through a portion of the fee generated through settlement. The CTs are delivered to the purchasers (e.g., recording a transfer transaction in the blockchain) originating a transaction. The CTs are both tied to value of fiat currency at the time of minting (which provides short-term stability to the token) and underpinned by the CT (which provides longer-term store of value).

In some embodiment, a transaction is processed by the SPN system as illustrated by the following example. A purchaser initiates a transaction with a retailer such as the purchase of a toy for $83.20. At the time of the transaction, ETH (i.e., Ethereum cryptocurrency) is valued $522.51, a CT is valued at 0.00125 ETH, and a PT is valued at 0.001 CT; the PT fee is 1.00%, and the transaction fee is 0.75%. During settlement of the transaction, a smart contract associated with the transaction debits $83.20 from the purchaser wallet of the purchaser (e.g., debiting the linked account or transferring PTs held in the purchaser wallet). The smart contract may supply the transaction amount to an oracle that returns the transaction fee of $0.6240 (i.e., $83.20*0.75%) is deducted from the transaction amount and credited to the DPG wallet. The oracle (or a different oracle) may also return a payment fee $0.8320 (i.e., $83.20*1.00%). The smart contract may deposit $81.744 (i.e., $83.20−$0.6240−$0.8320) in the retailer wallet. An oracle may also return a 1.274 CT value (i.e., $0.8320/($522.51*0.00125)). The smart contract then mints a PT with a value of 1,274.00 (i.e., 1.274 CT/0.001 PTs per CT) and transfers the PT to the purchaser wallet. In some embodiments, the smart contact may interact with a trust oracle which provides an indication of trustworthiness of the purchaser. For example, if a person reports that their smartphone is missing, the trustworthiness score may be low for purchases using that smartphone to conduct a transaction. The DPG system may decline transactions in part based on trustworthiness.

In some embodiments, a PT creation smart contract may dynamically create a number of PTs that are underpinned by CTs. A certain number of CTs may be minted in a single event (e.g., an ICO) or following a programmatic mathematical process of minting (e.g., mining). In contrast, the PTs are minted dynamically to meet demand. The PT creation smart contract is used to create the PTs and is invoked when the transaction smart contract invokes the PT creation smart contract (e.g., recording a message transaction) in a secure and trusted manner. A series of oracles are used to gather the various data points for the smart contract to successfully complete its task. A transaction smart contract serves as oracle for a number of data elements and provides them to the PT creation smart contract:
1.) Purchaser ID (“PID”);
2.) TransactionValue (the verified purchase amount);
3.) Currency used for transaction (e.g., USD); and
4.) Payment Fee Rate.
   The DPG system provides the following oracles to the PT creation smart contract:
1.) ExchangeRateXXX oracle, the value of the underpinning cryptocurrency on open market, in the currency used for transaction, where XXX is the three-letter code for the CryptoType;
2.) CryptoType oracle, the type of cryptocurrency to be used for underpinning purposes; and
3.) TranslationRate oracle, which establishes the ratio of cryptocurrency to token for this transaction.

The PT creation smart contract draws the underpinning cryptocurrency, CT, in the amount of the transaction value (the purchase amount) multiplied by the payment fee rate. The PT creation smart contract may buy CTs from an exchange, from a purchaser or retailer, or from the SPN system.

The PT creation smart contract then determines the amount of underpinned tokens PTs to create and the underpinning cryptocurrency CT to acquire. This may be determined as follows:

T_{payment}=TransactionValueValid*PaymentRate/ExchangeRateXXX*TranslationRate

And

C_{underpin}=for CryptoType,TransactionValueValid*PaymentRate/ExchangeRateXXX

The PT creation smart contract places C_{underpin} (the underpinning cryptocurrency) in a smart contract escrow and records to the blockchain the following elements:
1.) UserID of Buyer;
2.) T_{payment}, the number of PTs in escrow;
3.) TranslationRate, the ratio from PT to CT; and
4.) ClaimStatus is set to Unclaimed.
   ClaimStatus is a state variable designed such that tokens escrowed by the PT creation smart contract which are underpinned by CTs escrowed for such underpinning are not automatically allocated, but rather are allocated after a claim process.

Once the PT is created, it is placed in escrow for claim by the purchaser, and a blockchain transactions is recorded noting the value of the PT and the hashed UserID connected to the PTs, and the ClaimStatus state variable is created as Unclaimed. In some embodiments, the PTs may be automatically recorded as claimed or held unclaimed until a certain criterion is meet such as the purchaser participating in a threshold number of transactions.

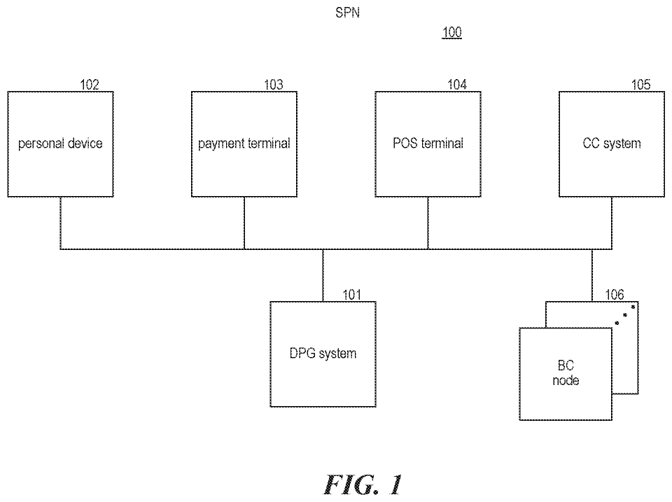

FIG. 1 is a block diagram that illustrates entities participating in the SPN. The SPN system includes a DPG system 101 that interfaces with personal devices 102, payment terminals 103, POS terminals 104, and credit card systems 105. The personal devices, payment terminals, POS terminals, and credit card systems may include payment applications that are part of the SPN system. The SPN system records various transactions in a blockchain 106. The transactions relate to purchase transactions, PT creation transactions, CT creation transactions, and so on.

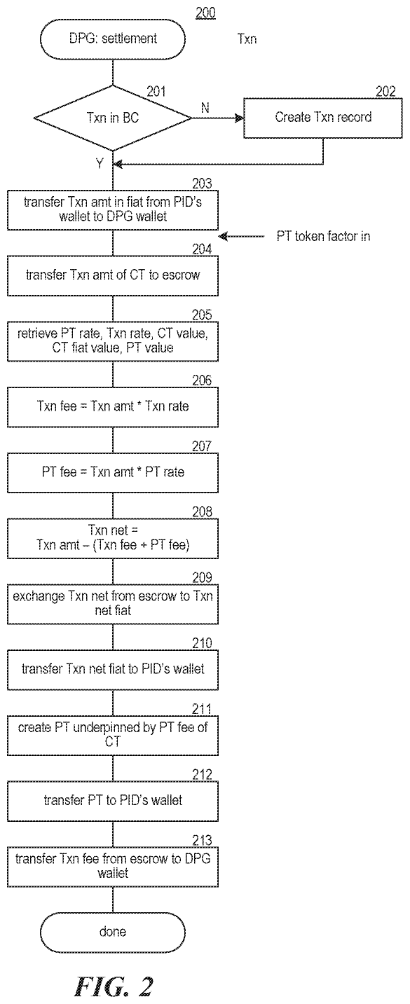

FIG. 2 is a flow diagram that illustrates the overall processing of settlements by the DPG system in some embodiments. A settlement component 200 is invoked passing an indication of an approved transaction that is to be settled. In decision block 201, if the transaction is already stored in the blockchain, then the component continues at block 203, else the component continues at block 202. In block 202, the component records in the blockchain a transaction record with details of the transaction such as transaction amount, product category, purchaser identifier, retailer identifier, and so on. In block 203, the component transfers a transaction amount of fiat currency from the purchaser wallet to a DPG wallet. In block 204, the component transfers the transaction amount of CTs to an escrow. In block 205, the component retrieves the PT rate (or payment rate), transaction rate, and CT and PT valuations. In block 206, the component calculates the transaction fee. In block 207, the component calculates the PT fee. In block 208, the component calculates the transaction net amount, which is the amount to be paid to the retailer. In block 209, the component exchanges the transaction net amount to a transaction net fiat amount based on the valuations. In block 210, the component transfers the transaction net fiat amount to the retailer wallet. The component may alternatively allocate CTs to the retailer wallet and the convert the CTs to fiat currency. In block 211, the component creates a PT that is underpinned by a PT fee amount of CTs. In block 212, the component transfers the PT to the purchaser's wallet. In block 213, the component transfers the transaction fee from escrow to the DPG wallet and completes.

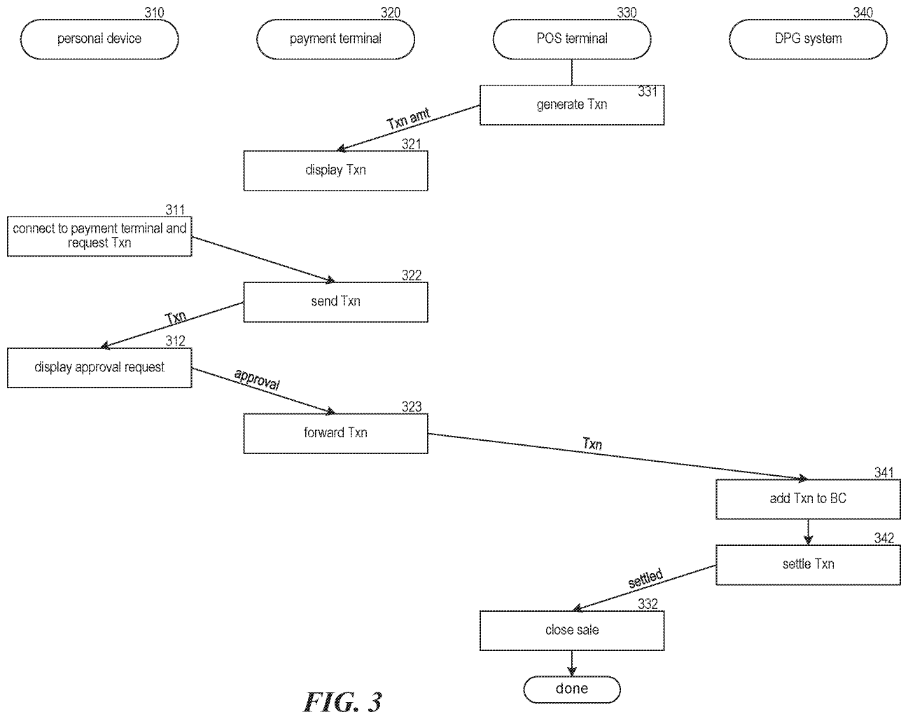

FIGS. 3-8 illustrate different methodologies for conducting transactions with the SPN system. The figures illustrate the interaction between a personal device of a purchaser, a payment terminal, a POS terminal, and the DPG system. These methodologies allow the SPN system to dynamically adapt to the differences in capabilities of the personal devices, payment terminals, POS terminals, credit card services, and e-commerce sites. The capabilities include wireless capabilities, SPN compatible capabilities, and so on.

FIG. 3 illustrates a methodology in which a payment terminal has a wireless capability. Initially, POS terminal 330 generates 331 a transaction that includes transaction amount, product identifier, and retailer identifier. The POS terminal provides the transaction amount to the payment terminal 320. The payment terminal displays 321 the transaction amount to the purchaser. The personal device 310 then establishes 311 a secure connection with the payment terminal. The payment terminal sends 322 transaction information to the personal device. The personal device displays 312 a request for approval and sends an indication of the approval to the payment terminal. Upon receiving the approval, the payment terminal forwards 323 the approved transaction to the DPG system 340. The DPG system 340, upon receiving the transaction, records 341 a transaction in the blockchain. The DPG system then invokes 342 the settlement component to settle the transaction. The DPG system then notifies the POS terminal that the transaction has been settled. The POS terminal then closes 332 the sale and completes. Alternatively, the DPG system may notify the payment terminal that the transaction has settled and the payment terminal and then notify the POS terminal that the transaction has settled. In such a case, the POS terminal may not have a SPN application.

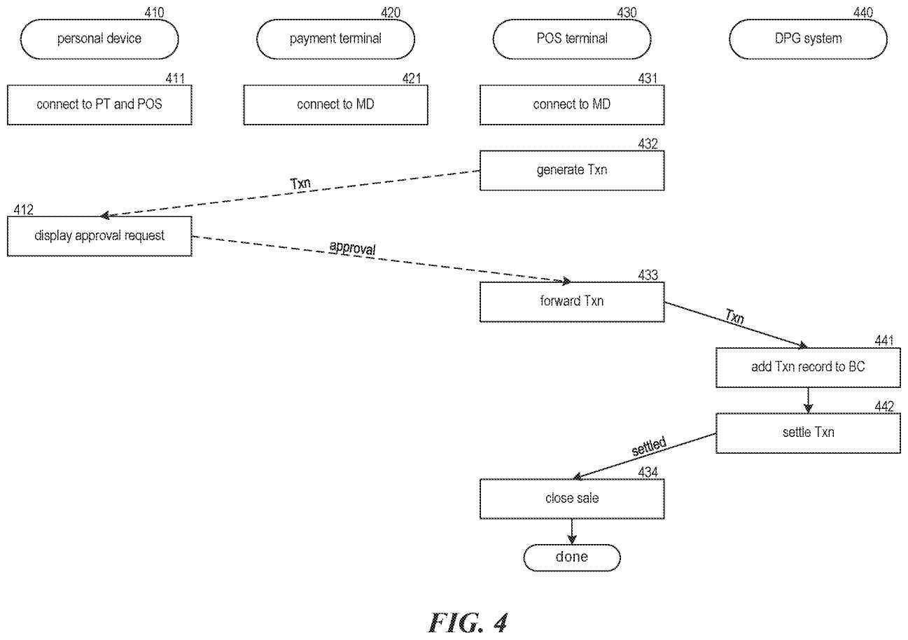

FIG. 4 illustrates a methodology in which a payment terminal and/or POS terminal has a wireless capability. With this methodology, the payment terminal may not have an SPN application and may operate only as a pass-through (e.g., indicated by dashed lines) to the personal device when the POS terminal does not have a wireless capability. Initially, the personal device 410 and the payment terminal 420 and/or POS terminal 430 establish 411, 421, and 431 a secure connection. The POS terminal generates 432 a transaction and sends the transaction to the personal device. The personal device displays 412 an approval request and sends an indication the approval to the POS terminal. The POS terminal forwards 433 the approved transaction to the DPG system 440. The DPG system adds 441 a transaction to the blockchain. In block 442, the DPG system invokes 442 a settlement component to settle the transaction and notifies the POS terminal of the settlement. The POS terminal then closes 434 the sale and completes.

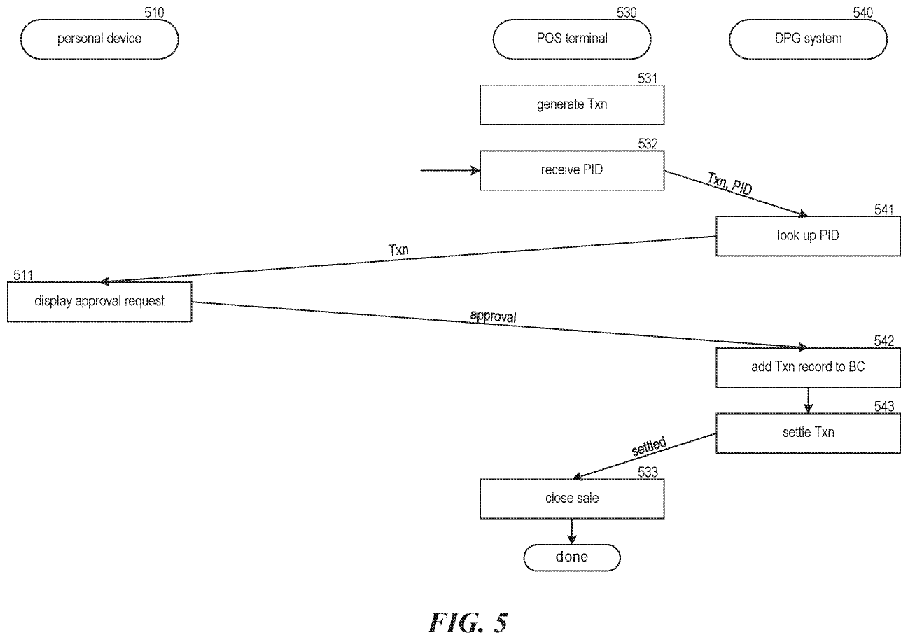

FIG. 5 illustrates a methodology in which no payment terminal is available and the POS terminal does not have wireless capability. Initially, the POS terminal 530 generates 531 the transaction. The POS terminal receives 532 a purchaser identifier such as an email address or phone number that may be provided by the purchaser. The POS terminal then sends the transaction and the purchaser identifier to the DPG system 540. The DPG system retrieves 541 information about the purchaser and verifies their status as a participant in the SPN. The DPG system then notifies the personal device 510 of the transaction. The personal device displays 511 an approval request for the transaction and sends an indication the approval to the DPG system. Upon receiving the approval, the DPG system records 542 the transaction in the blockchain. The DPG system then invokes 543 the settlement component to settle the transaction. The DPG system then notifies the POS terminal of the settlement. The POS terminal then closes 533 the sale and then completes.

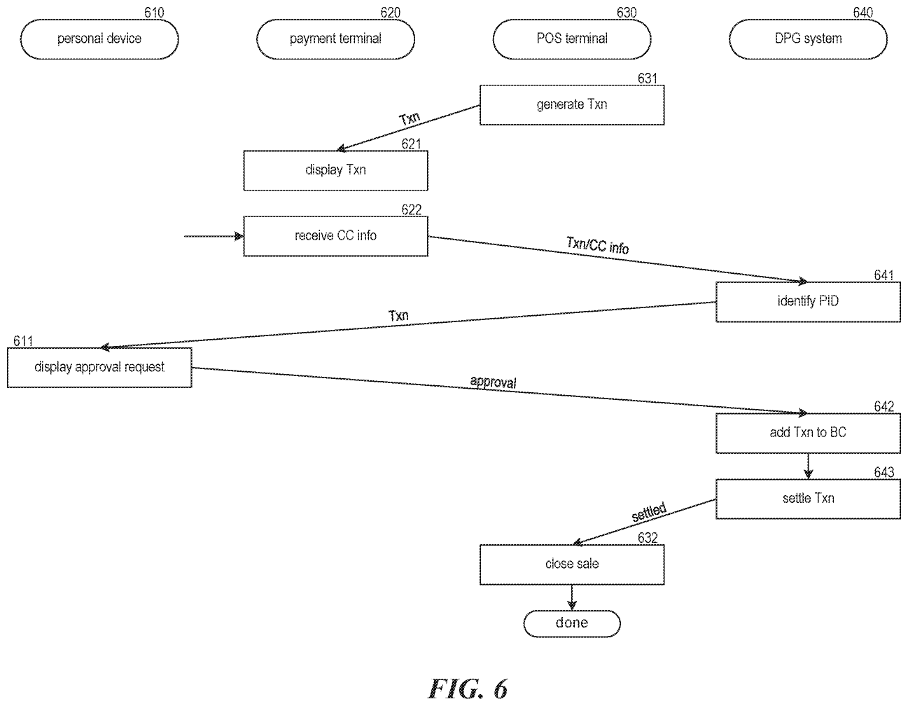

FIG. 6 illustrates a methodology in which neither the payment terminal nor the POS terminal has wireless capability. The POS terminal 630 generates 631 the transaction and notifies the payment terminal 620 of the transaction. The payment terminal displays 621 transaction information to the purchaser. The payment terminal then receives 622 credit card information from the credit card of the purchaser. The payment terminal sends transaction and credit card information to the DPG system. The DPG system 640 retrieves 641 the identifier of the purchaser and verifies that they are authorized to use the SPN. The DPG system then provides the transaction to the personal device 610. The personal device 610 displays 611 an approval request and sends an indication the approval to the DPG system. The DPG system adds 642 the transaction to the blockchain. The DPG system invokes 643 the settlement component to settle the transaction and notifies the POS terminal of the settlement. The POS terminal then closes 632 the sale and completes.

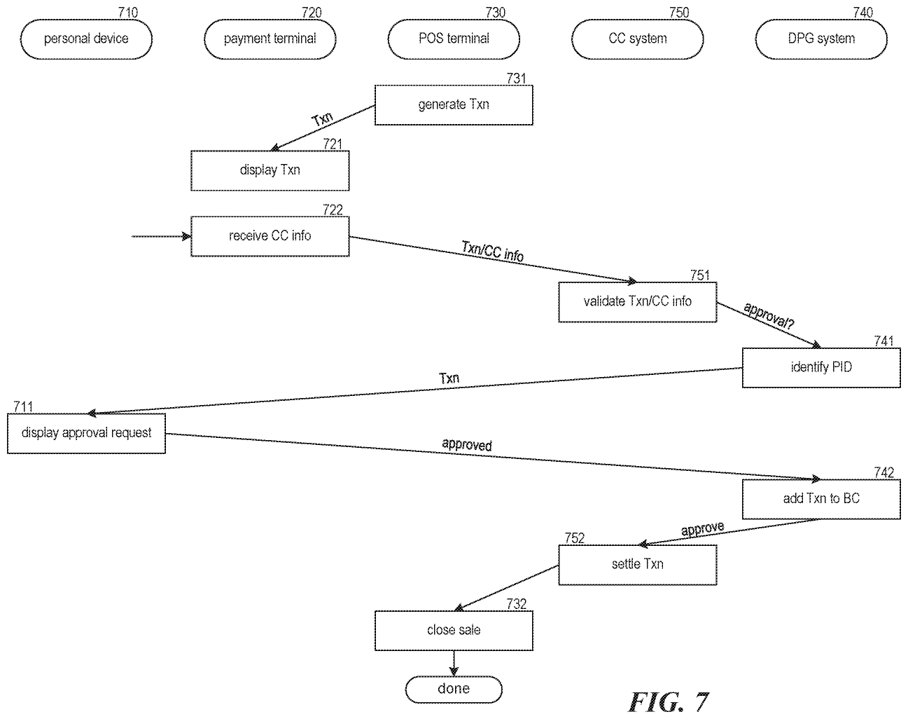

FIG. 7 illustrates a methodology in which neither the payment terminal nor the POS terminal has SPN capabilities. The POS terminal 730 generates 731 the purchase transaction and forwards it to the payment terminal 720. The payment terminal displays 721 the transaction to the purchaser. The payment terminal then receives 722 credit card information from the credit card of the purchaser. The payment terminal then forwards the transaction and credit card information to the credit card system 750 (e.g., Visa processing system). The credit card system validates 751 the transaction and credit card and forwards an approval request to the DPG system 740. The DPG system retrieves 741 the purchaser identifier and forwards the transaction to the personal device 710 of the purchaser. The personal device displays 711 an approval request and sends an indication the approval to the DPG system. The DPG system adds 742 a transaction to the blockchain and sends an approval notification to the credit card system. The credit card system then settles 752 the transaction and notifies the POS terminal. The POS terminal closes 732 the sale and completes.

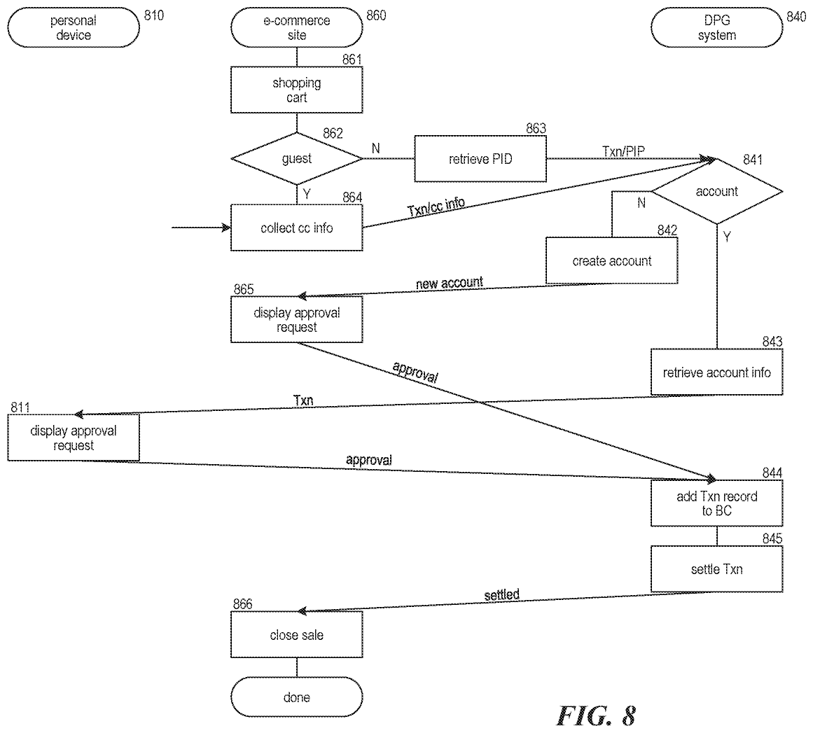

FIG. 8 illustrates methodologies for employing SPN capabilities at an e-commerce web site. A purchaser at an e-commerce site 860 designates items to be purchased, and the e-commerce site displays 861 shopping cart information for the purchase transaction. The purchaser may decide to checkout as a guest or use an existing account at the e-commerce site. If the purchaser selects a guest checkout, the e-commerce site collects 864 credit card information from the purchaser and sends the transaction and credit card information to the DPG system 840. If the purchaser selects an account checkout, the e-commerce site retrieves 863 account information and sends the transaction and an identifier of the purchaser to the DPG system. If the purchaser does not have an account with the SPN system, the DPG system creates 842 an account and notifies the e-commerce site that an account has been created. Although not illustrated, the e-commerce site may solicit approval of the purchaser to create a purchaser wallet (an account) with the SPN system. The e-commerce site then displays 865 an approval request for the transaction and sends an indication of the approval to the DPG system. If the purchaser does have an account with the SPN system, the DPG system retrieves 843 account information and sends the transaction to the personal device 810 of the purchaser. The personal device displays 811 an approval request and sends an indication of the approval to the DPG system. Upon receiving an indication that the purchaser has approved the transaction either via the e-commerce site or the personal device, the DPG system adds 844 a transaction to the blockchain. The DPG system then settles 845 the transaction and notifies the e-commerce site. The e-commerce site closes 866 the sale and completes. In some embodiments, the SPN system may support creating of an account with the SPN system when a customer creates an account with an e-commerce site irrespective of whether the customer is making a purchase. In a case, the processing of steps 864, 841, and 842 would be used to create the account that includes the purchaser wallet. When the customer subsequently makes a purchase, the processing of step 861, 862, 863, 841, 843, 811, 844, 845, and 866 would be used to settle the transaction.

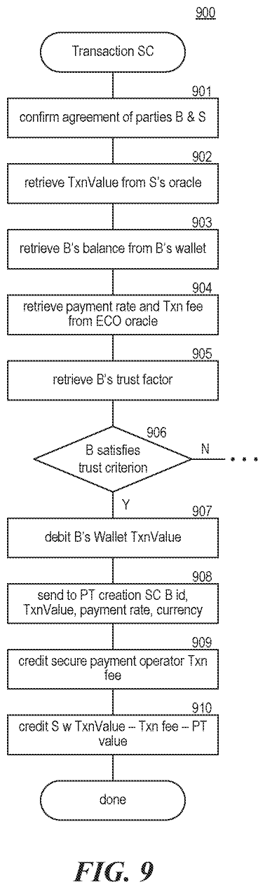

FIG. 9 is a flow diagram that illustrates the processing of a transaction smart contract of the secure payment system in some embodiments. A transaction smart contract component executes to coordinate the processing of a transaction. In block 901, the component confirms agreement of the parties to the transaction. The parties include a buyer (“B”) and one or more sellers (“S”). In block 902, the component retrieves a transaction value (“TxnValue”) from an oracle provided by the seller that provides pricing information. In block 903, the component retrieves the current balance from the buyer's wallet. In block 904, the component retrieves payment rate and transaction fee information from an oracle provided by ecosystem. In block 905, the component retrieves a trust factor for the buyer. The trust factor may be generated by a trust factor smart contract that analyzes transactions to determine the trustworthiness of a buyer. In decision block 906, if the buyer satisfies a trust criterion then the component continues at block 907, else the component performs error processing. The trust criterion may be based on, for example, a combination of the trust factor and the transaction value. In block 907, the component debits the buyer's wallet by the transaction value. In block 908, the component sends to an RT creation smart contract an identifier of the buyer, the transaction value, the payment rate, and the currency that the transaction is in (e.g., US dollars). In block 909, the component credits the operator of the secure payment system with the transaction fee. In block 910, the component credits the seller with the transaction value minus the transaction fee and the value of the PT. The component then completes.

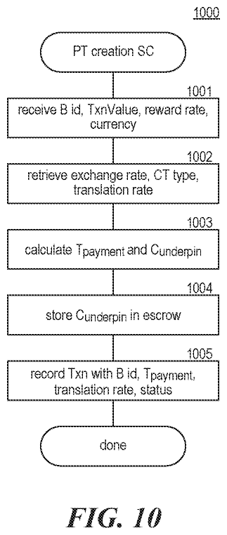

FIG. 10 is a flow diagram that illustrates the processing of a PT creation smart contract of the secure payment system in some embodiments. The PT creation smart contract component 1000 executes to create a PT. In block 1001, the component receives a buyer identifier, a transaction value, a payment rate, and the currency type. In block 1002, the component retrieves the current exchange rate, the type of the currency token, and a translation rate. In block 1003, the component calculates the amount of PTs as the award and the corresponding value of the CT. In block 1004, the component stores the value of the CT in escrow. In block 1005, the component records a transaction in the blockchain with the buyer identifier, the amount of the PT, the translation rate and the current status as the payment being unclaimed. The component then completes.

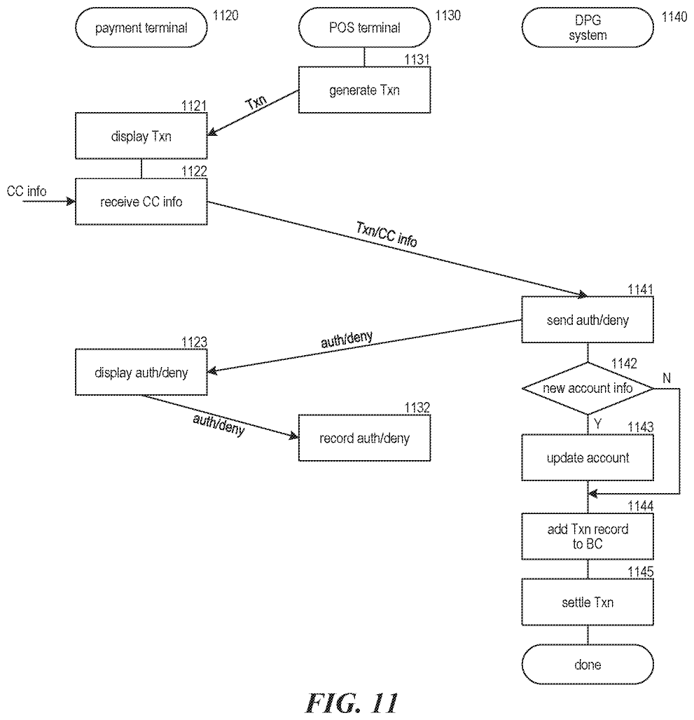

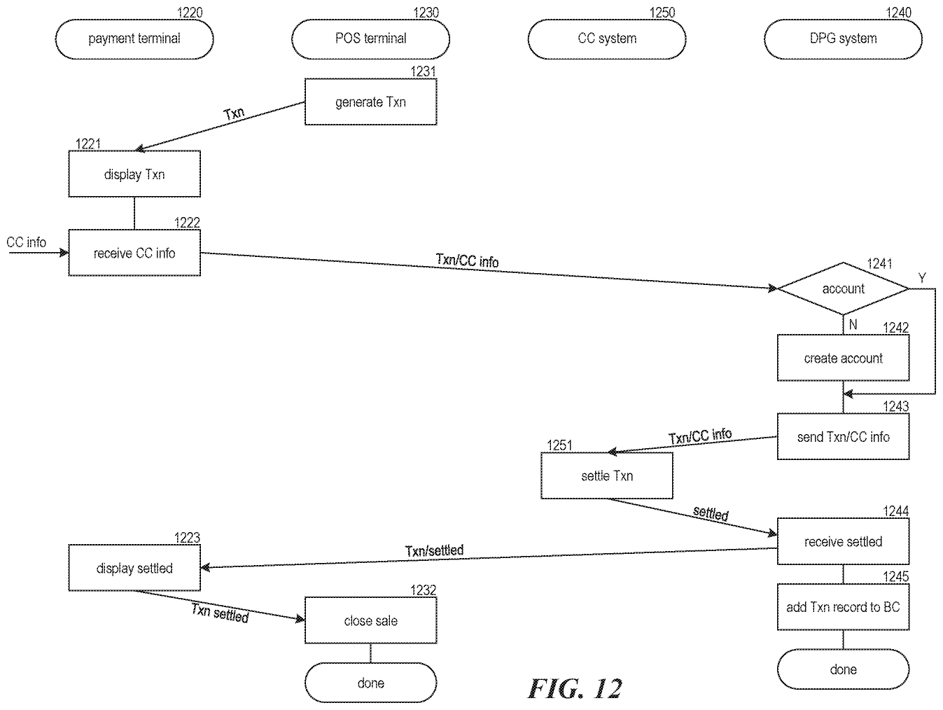

FIGS. 11-12 illustrate methodologies for dynamic provisioning (e.g., updating and creating) of purchaser accounts in some embodiments. FIG. 11 illustrates methodologies of the SPN system for paying from purchaser account by presenting a credit card at a payment terminal even without the purchaser having a personal device. The POS terminal 1130 generates 1131 a transaction and notifies the payment terminal 1120 of the transaction. The payment terminal displays 1121 transaction information to the purchaser. The payment terminal then receives 1122 credit card information from the credit card (or other payment card) of the purchaser (e.g., via a smart card or magnetic strip on the payment card). The payment terminal sends the transaction and credit card information to the DPG system 1140. The DPG system identifies the purchaser wallet using the credit card information, determines whether to authorize or deny the transaction, and sends 1141 an indication of the authorization or denial to the payment terminal. The DPG system denies the transaction, for example, if the purchaser does not have a payment account. Upon receiving the indication of the authorization or denial, the payment terminal displays 1123 the authorization or denial message to the purchaser and sends an indication of the authorization or denial to the POS terminal. The POS terminal records 1132 an indication of the authorization or denial. After the DPG system sends the indication of the authorization or denial, the DPG system determines 1142 whether the credit card information represents new information about the purchaser. If so, the DPG system updates 1143 the purchaser account based on the new credit card information. Irrespective of whether the account is updated, the DPG system adds 1144 a transaction to the blockchain. The DPG system then invokes 1145 a settlement component to settle the transaction and then completes. In some embodiments, the DPG system may offer the purchaser via the payment terminal (or personal device) the option to pay from the purchaser account or using the credit card information. If the user has a purchaser account and selects to pay from the purchaser account, then the DPG system proceeds as illustrated in FIG. 11. If, however, the purchaser instead selects to pay using the credit card information, the DPG system submits the transaction and the credit card information to a credit card system as illustrated in FIG. 12. If the purchaser, however, does not have a purchaser account, the DPG system may automatically create the purchaser account or may ask the purchaser if the purchaser wants a purchaser account prior to creating the purchaser account. If the DPG system creates the purchaser account, the DPG system may give the purchaser the option to pay from the purchaser account or using the credit card information.

FIG. 12 illustrates methodologies of the SPN system for handling credit card payments and when the purchaser has no purchaser account, opening a purchaser account. The POS terminal 1230 generates 1231 the transaction and notifies the payment terminal 1220 of the transaction. The payment terminal displays 1221 the transaction information to the purchaser. The payment terminal then receives 1222 credit card information from the credit card of the purchaser and sends the transaction and credit card information to the DPG system 1240. Upon receiving the transaction and credit card information, the DPG system determines 1241 whether the purchaser has a purchaser account based on the credit card information. If the purchaser does not have a purchaser account, then the DPG system creates 1242 a purchaser account. Irrespective of whether the purchaser had a purchaser account, the DPG system sends the transaction and credit card information to credit card system 1250. The credit card system settles 1251 the transaction and notifies the DPG system of the settlement. Upon receiving the notification of settlement, the DPG sends 1244 an indication of the settled transaction to the payment terminal. The payment terminal displays 1223 an indication that the transaction has been settled and notifies the POS terminal. The POS terminal then closes 1230 the sale and then completes. The DPG system also adds 1245 a transaction to the blockchain and then completes. In an alternative embodiment, the DPG system may also provide the purchaser (e.g., identified by the payment information) who already has a purchaser account an option to pay for the purchase through that purchaser account rather than through the credit card account. Prior to sending the transaction and credit card information to the credit card system, the DPG system may send a prompt (e.g., via a user interface) to the purchaser via the payment terminal or the purchaser's personal device asking whether the purchaser wants to pay with their purchaser account. The prompt may identify the SPN system (e.g., via a logo) and offer financial incentive (e.g., discount on purchase price or token) to the purchaser for paying via the purchaser account. If the purchaser does want to pay with the purchaser account, the DPG system settles the transaction and notifies the payment terminal. If the purchaser does not, the DPG system sends the transaction and credit card information to the credit card system and proceeds as illustrated in FIG. 12.

Provisioning a digital wallet or account refers to the accumulation of personal information, financial information, or other information by an electronic device or online service such that it creates a set of records sufficient for the intended purpose of the digital wallet or account. The intended purposes for a digital wallet or account can include settling of financial transactions, confirmation of identity, and so on. In one embodiment, the provisioning of a digital wallet or account may be based on personal, financial, and other information found in a payment transaction process. Similarly, the updating of a digital wallet or account may be based on personal information found in a payment transaction, financial information found in a payment transaction, personal information found in an identity transaction, financial information found in an identity transaction, and so on.

A digital wallet refers to an electronic device or online service that allows an individual or individuals to store personal information, financial information, electronic representations of currency and/or currency equivalents such as cryptocurrency. In one embodiment, digital wallets may be used to settle financial transactions. These transactions can include purchasing goods or services on-line or at a physical store, using a computer, a smartphone, a wearable mobile device and so on. Settling these financial transactions can be done with the transfer of representations of currency and/or currency equivalents such as cryptocurrency, which can be deposited in the digital wallet prior to such transaction or, in other cases, can be drawn from an individual's bank account, banking debit card, charge card, or credit card which is linked to the digital wallet such that the payment needed for a given transaction can be dynamically placed in the digital wallet. In another embodiment, digital wallets may be used to confirm identity using credentials such as driver's license, health insurance card, loyalty card(s), cryptographically secure exchange of key information, or other ID documents stored within the wallet. In another embodiment, the identity credentials contained in a digital wallet can be passed to a merchant's terminal wirelessly via near field communication (NFC), low energy Bluetooth (BLE), or other communications protocol or may be identified outside of electronic means by the individual or individuals providing a code, identifying information, or similar lookup method such that the card terminal, point of sale, or similar device can use a communications network to connect to a server to confirm the presence of the digital wallet, and then in turn trigger a confirmation on the digital wallet to authorize the purchase. A cryptocurrency wallet is a type of digital wallet where private keys are stored for cryptocurrencies like bitcoin.

The computing systems (e.g., network nodes or collections of network nodes) on which the secure payment system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the secure payment system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The secure payment system may be described in the general context of computer-executable instructions, such as program modules and components, executed by one or more computers, processors, or other devices. Generally, program modules or components include routines, programs, objects, data structures, and so on that perform tasks or implement data types of the BPQS system. Typically, the functionality of the program modules may be combined or distributed as desired in various examples. Aspects of the secure payment system may be implemented in hardware using, for example, an application-specific integrated circuit (“ASIC”) or field programmable gate array (“FPGA”).

The following paragraphs describe various embodiments of aspects of the SPN system. Implementations of the system may employ any combination of the embodiments and aspects of the embodiments. The processing described below may be performed by a computing system with a processor that executes computer-executable instructions stored on a computer-readable storage medium that implements the system.

In some embodiments, a method performed by one or more computing systems is provided for securely conducting a transaction to help prevent fraudulent transactions. Under control of a payment application executing on a personal device of a purchaser, the method establishes a secure connection to a payment terminal of a seller. The method receives via the secure connection transaction information generated by a point-of-sale system. The method prompts the purchaser to approve the transaction. Upon approval, the method sends via the secure connection with the payment terminal an indication of the approved transaction to a digital payment system. Under control of the digital payment system, upon receiving the approved transaction, the method adds, he approved transaction to a distributed ledger, settles the approved transaction, and provides notification of the settlement to the point-of-sale system. In some embodiments, the settling of the transaction includes transferring a payment token to a purchaser wallet of the purchaser. In some embodiments, the payment token is underpinned with a cryptocurrency token. In some embodiments, a previously issued payment token is used when settling the transaction. In some embodiments, the method further maintains a purchaser wallet for the purchaser that is linked to a payment (financial) account of the purchaser. In some embodiments, the settling of the transaction includes transferring a payment token to the purchaser wallet of the purchaser. In some embodiments, the establishing of the secure connection is based on exchanging public keys of public/private key pairs. In some embodiments, the establishing of the connection includes creating a symmetric key based on the public keys.

In some embodiments, a method performed by one or more computing systems is provided for securely conducting a transaction to reduce fraud. Under control of a payment application executing on a personal device of a purchaser, the method establishes a secure connection to a point-of-sale terminal of a seller. The method receives via the secure connection transaction information generated by a point-of-sale system. The method prompts the purchaser to approve the transaction. Upon approval, the method sends via the secure connection with the point-of-sale terminal an indication of the approved transaction to a digital payment system. Under control of the digital payment system, upon receiving the approved transaction, the method adds the approved transaction to a distributed ledger, settles the approved transaction, and provides notification of the settlement to the point-of-sale system. In some embodiments, the settling of the transaction includes transferring a payment token to a purchaser wallet of the purchaser. In some embodiments, the payment token is underpinned with a cryptocurrency token. In some embodiments, a previously issued payment token is used when settling the transaction. In some embodiments, the method further maintains a purchaser wallet for the purchaser that is linked to a payment account of the purchaser. In some embodiments, the settling of the transaction includes transferring a payment token to the purchaser wallet of the purchaser. In some embodiments, the establishing of the secure connection is based on exchanging public keys of public/private key pairs. In some embodiments, the establishing of the connection includes creating a symmetric key based on the public keys.

In some embodiments, one or more computing systems are provided for securely conducting a transaction to reduce risk of fraudulent transaction, the one or more computing systems comprise one or more computer-readable storage mediums for storing computer-executable instructions for controlling the one or more computing systems and one or more processors for executing the computer-executable instructions stored in the one or more computer-readable storage mediums. The instructions of digital payment system receive from a point-of-sale system an indication of a transaction and an identifier of a purchaser, retrieve information on the purchaser identified by the identifier, send an approval request to a personal device of the purchaser, and upon receiving an indication of the approval, add the approved transaction to a distributed ledger, settle the approved transaction, and provide notification of the settlement to the point-of-sale system In some embodiments, the instructions that settle a transaction include instructions to calculate a transaction fee and a payment fee, allocate a cryptocurrency token corresponding to a transaction amount, credit an account of a merchant with a cryptocurrency token corresponding to the transaction amount less the transaction fee and payment fee, and allocate a payment token to the purchases corresponding to the payment fee, the payment token being underpinned by a cryptocurrency token.

In some embodiments, one or more computing systems are provided for dynamically generating payment tokens for use in reducing fraudulent transactions. The one or more computing system comprise one or more computer-readable storage mediums for storing computer-executable instructions for controlling the one or more computing systems and one or more processors for executing the computer-executable instructions stored in the one or more computer-readable storage mediums. Under control of a payment token creation smart contract recorded in a blockchain, the instructions receive from a transaction smart contract a buyer identifier, a transaction value, and a payment rate. The instructions receive from one or more oracles an exchange rate and a translation rate. The instructions calculate a payment token value based on the transaction value, the receipt rate, the exchange rate, and the translation rate. The instructions calculate a cryptocurrency token value based on the transaction value, receipt rate, and exchange rate. The instructions store in escrow an amount of cryptocurrency tokens of the cryptocurrency token value. The instructions record in the blockchain a transaction representing a payment token that includes the buyer identifier, the receipt value, the translation rate, and a status of unclaimed. In some embodiments, the payment token is specified as unclaimed so that the payment token cannot be used for payment. In some embodiments, the payment token is specified as claimed when a claimed criterion is satisfied so that the payment token can be used for payment.

In some embodiments, a method performed by one or more computing systems is provided for dynamically generating payment tokens. The method under control of a payment token creation smart contract recorded in a blockchain, receives from a transaction smart contract a buyer identifier, a transaction value, and a payment rate. The method receives from one or more oracles an exchange rate and a translation rate. The method calculates a payment token value based on the transaction value, the receipt rate, the exchange rate, and the translation rate. The method calculates a currency token value based on the transaction value, receipt rate, and exchange rate. The method stores in escrow an amount of currency tokens of the currency token value. The method records in the blockchain a transaction representing a payment token that includes the buyer identifier, the receipt value, the translation rate, and a status of unclaimed. In some embodiments, the payment token is specified as unclaimed so that the payment token cannot be used for payment. In some embodiments, the payment token is specified as claimed when a claimed criterion is satisfied so that the payment token can be used for payment.

In some embodiments, a method performed by one or more computing systems is provided for securely conduction a transaction to reduce risk of a fraudulent transaction. The method receives from an e-commerce site an indication of a transaction and information relating to the purchaser. Upon determining that the purchaser has an account with a digital payment system, the method sends to a personal device of the purchaser an indication of the transaction. The method receives from the personal device of the purchaser an indication that the purchaser has approved the transaction. The method settles the transaction using a financial account linked to the account of the purchaser. The method notifies the e-commerce site that the transaction has been settled. In some embodiments, upon determining that the purchaser does not have an account with the digital payment system, the method creates an account for that purchaser that is linked to a financial account identified in the information relating to the purchaser.

In some embodiments, a method performed by one or more computing systems is provided for dynamically provisioning purchaser accounts based on transaction information and payment information. The method receives from one or more payment terminals via secure connections transaction information and payment information for a plurality of transactions. The method identifies the purchaser of each transaction based on the payment information. For at least one of the identified purchasers, the method creates a purchaser account based on the identified purchaser not having a purchaser account. For at least one of the identified purchasers, the method updates the purchaser account based on the payment information based on the identified purchaser having a purchaser account. The method settles each transaction using the purchaser account or the payment information of each transaction. In some embodiments, when the transaction is settled using the purchaser account, transferring a payment token to the purchaser account of the purchaser. In some embodiments, the secure connection is established based on exchanging public keys of public/private key pairs. In some embodiments, the method further notifies the payment terminal from which transaction information and payment information was received that the transaction has been approved. In some embodiments, the method further receives from the payment terminal from which transaction information and payment information was received an indication that the purchaser wants to create a purchaser account. In some embodiments, the settling of a transaction using the payment information includes sending the transaction information and the payment information to a system for handling payments. In some embodiments, the system for handling payments is a credit card processing system. In some embodiments, the payment information is credit card information. In some embodiments, the payment information is derived from information associated with a payment card. In some embodiments, the payment information is retrieved from a smart card.

In some embodiments, one or more computing systems are provided for dynamically provisioning purchaser accounts based on transaction information and payment information. The one or more computing systems comprise one or more computer-readable storage mediums for storing computer-executable instructions and one or more processors for executing the computer-executable instructions stored in the one or more computer-readable storage mediums. The instructions control the one or more computing systems to receive from a payment terminal via a secure connection transaction information and payment information. The instructions control the one or more computing systems to identify a purchaser account based on the payment information. The instructions control the one or more computing systems to update the purchaser account based on the payment information. The instructions control the one or more computing systems to settle the transaction. In some embodiments, the transaction is settled using the payment information. In some embodiments, the transaction is settled using the purchaser account. In some embodiments, the instructions control the one or more computing systems to create a purchaser account when a purchaser account is not identified. In some embodiments, the instructions control the one or more computing systems to receive from the payment terminal an indication that the purchaser wants to create a purchaser account. In some embodiments, the instructions control the one or more computing systems to, when the transaction is settled using the purchaser account, transfer a payment token to the purchaser account of the purchaser. In some embodiments, the secure connection is established based on exchanging public keys of public/private key pairs. In some embodiments, the instructions control the one or more computing systems to notify the payment terminal that the transaction has been approved.

In some embodiments, a method performed by one or more computing systems is provided for processing a payment for a transaction. The method receives from a payment terminal via a secure connection transaction information and payment information for a transaction. The payment information is derived from a payment card of a purchaser. The payment card is associated with a payment service. The identifies the purchaser from the payment information. When the purchaser has a purchaser account, the method processes payment for the transaction via the purchaser account rather than the payment service. In some embodiments, prior to processing the payment for the transaction via the purchaser account, the method prompts the purchaser whether to process the payment via the purchaser account rather than the payment service. In some embodiments, the prompting indicates an incentive is to be provided to the purchaser if the payment is via the purchaser account. In some embodiments, when the transaction is settled, the method transfers a payment token to the purchaser account of the purchaser. In some embodiments, the secure connection is established based on exchanging public keys of public/private key pairs. In some embodiments, the method further notifies the payment terminal from which transaction information and payment information was received that the transaction has been approved. In some embodiments, the payment service is a credit card processing system. In some embodiments, the payment card is a credit card. In some embodiments, the payment card is a smart card.

In some embodiments, one ne or more computing systems is provided for processing a payment for a transaction via a purchaser account of a purchaser. The one or more computing systems comprise one or more computer-readable storage mediums for storing computer-executable instructions and one or more processors for executing the computer-executable instructions stored in the one or more computer-readable storage mediums. The instructions receive from a payment terminal via a secure connection transaction information and payment information for a transaction. The payment information is derived from a payment card of the purchaser. The payment card is associated with a payment service. The instructions identify the purchaser from the payment information. The instructions process payment for the transaction via the purchaser account rather than the payment service. In some embodiments, the instructions further prior to processing the payment for the transaction via the purchaser account, prompt the purchaser whether to process the payment via the purchaser account rather than the payment service. In some embodiments, the prompting indicates an incentive is to be provided to the purchaser if the payment is via the purchaser account. In some embodiments, the instructions further when the transaction is settled, transfer a payment token to the purchaser account of the purchaser. In some embodiments, the secure connection is established based on exchanging public keys of public/private key pairs. In some embodiments, the instructions further notify the payment terminal from which transaction information and payment information was received that the transaction has been approved. In some embodiments, the payment service is a credit card processing system. In some embodiments, the payment card is a credit card. In some embodiments, the payment card is a smart card.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by one or more computing systems for dynamically provisioning purchaser accounts based on transaction information and payment information, the method comprising:
receiving from one or more payment terminals via secure connections transaction information and payment information for a plurality of transactions;
identifying the purchaser of each transaction based on the payment information;
for at least one of the identified purchasers, creating a purchaser account based on the identified purchaser not having a purchaser account;
for at least one of the identified purchasers, updating the purchaser account based on the payment information based on the identified purchaser having a purchaser account; and
settling each transaction using the purchaser account or the payment information of each transaction.

2. The method of claim 1 wherein when the transaction is settled using the purchaser account, transferring a payment token to the purchaser account of the purchaser.

3. The method of claim 1 wherein the secure connection is established based on exchanging public keys of public/private key pairs.

4. The method of claim 1 further comprising notifying the payment terminal from which transaction information and payment information was received that the transaction has been approved.

5. The method of claim 1 further comprising receiving from the payment terminal from which transaction information and payment information was received an indication that the purchaser wants to create a purchaser account.

6. The method of claim 1 wherein the settling of a transaction using the payment information includes sending the transaction information and the payment information to a system for handling payments.

7. The method of claim 6 wherein the system for handling payments is a credit card processing system.

8. The method of claim 1 wherein the payment information is credit card information.

9. The method of claim 1 wherein the payment information is derived from information associated with a payment card.

10. The method of claim 9 wherein the payment information is retrieved from a smart card.

11. One or more computing systems for dynamically provisioning purchaser accounts based on transaction information and payment information, the one or more computing systems comprising:
one or more computer-readable storage mediums for storing computer-executable instructions for controlling the one or more computing systems to:
receive from a payment terminal via a secure connection transaction information and payment information;
identify a purchaser account based on the payment information;
updating the purchaser account based on the payment information; and
settling the transaction; and
one or more processors for executing the computer-executable instructions stored in the one or more computer-readable storage mediums.

12. The one or more computing systems of claim 11 wherein the transaction is settled using the payment information.

13. The one or more computing systems of claim 11 wherein the transaction is settled using the purchaser account.

14. The one or more computing systems of claim 11 wherein the computer-executable instructions are for controlling the one or more computing systems to create a purchaser account when a purchaser account is not identified.

15. The one or more computing systems of claim 14 wherein the computer-executable instructions are for controlling the one or more computing systems to receive from the payment terminal an indication that the purchaser wants to create a purchaser account.

16. The one or more computing systems of claim 11 wherein the computer-executable instructions are for controlling the one or more computing systems to, when the transaction is settled using the purchaser account, transfer a payment token to the purchaser account of the purchaser.

17. The one or more computing systems of claim 11 wherein the secure connection is established based on exchanging public keys of public/private key pairs.

18. The one or more computing systems of claim 11 wherein the computer-executable instructions are for controlling the one or more computing systems to notify the payment terminal that the transaction has been approved.

19. A method performed by one or more computing systems for processing a payment for a transaction, the method comprising:
receiving from a payment terminal via a secure connection transaction information and payment information for a transaction, the payment information derived from a payment card of a purchaser, the payment card associated with a payment service;
identifying the purchaser from the payment information; and
when the purchaser has a purchaser account, processing payment for the transaction via the purchaser account rather than the payment service.

20. The method of claim 19 further comprising prior to processing the payment for the transaction via the purchaser account, prompting the purchaser whether to process the payment via the purchaser account rather than the payment service.

21. The method of claim 20 wherein the prompting indicates an incentive is to be provided to the purchaser if the payment is via the purchaser account.

22. The method of claim 19 wherein when the transaction is settled, transferring a payment token to the purchaser account of the purchaser.

23. The method of claim 19 wherein the secure connection is established based on exchanging public keys of public/private key pairs.

24. The method of claim 19 further comprising notifying the payment terminal from which transaction information and payment information was received that the transaction has been approved.

25. The method of claim 19 wherein the payment service is a credit card processing system.

26. The method of claim 19 wherein the payment card is a credit card.

27. The method of claim 19 wherein the payment card is a smart card.

28. One or more computing systems for processing a payment for a transaction via a purchaser account of a purchaser, the one or more computing system comprising:
one or more computer-readable storage mediums for storing computer-executable instructions for controlling the one or more computing systems to:
receive from a payment terminal via a secure connection transaction information and payment information for a transaction, the payment information derived from a payment card of the purchaser, the payment card associated with a payment service;
identify the purchaser from the payment information; and
process payment for the transaction via the purchaser account rather than the payment service; and
one or more processors for executing the computer-executable instructions stored in the one or more computer-readable storage mediums.

29. The one or more computing systems of claim 28 wherein the instructions further prior to processing the payment for the transaction via the purchaser account, prompt the purchaser whether to process the payment via the purchaser account rather than the payment service.

30. The one or more computing systems of claim 29 wherein the prompting indicates an incentive is to be provided to the purchaser if the payment is via the purchaser account.

31. The one or more computing systems of claim 28 wherein the instructions further when the transaction is settled, transfer a payment token to the purchaser account of the purchaser.

32. The one or more computing systems of claim 28 wherein the secure connection is established based on exchanging public keys of public/private key pairs.

33. The one or more computing systems of claim 28 wherein the instructions further notify the payment terminal from which transaction information and payment information was received that the transaction has been approved.

34. The one or more computing systems of claim 28 wherein the payment service is a credit card processing system.

35. The one or more computing systems of claim 28 wherein the payment card is a credit card.

36. The one or more computing systems of claim 28 wherein the payment card is a smart card.
